(19) United States
(12) Patent Application Publication
(10) Pub. No.: US 2020/0242675 A1
(43) Pub. Date: Jul. 30, 2020

(54) Virtual Storefronts for Controlled-Environment Facilities

(71) Applicant: Securus Technologies, Inc., Dallas, TX (US)

(72) Inventors: Matthew Richard Smith, McKinney, TX (US); Russell Wayne Roberts, Colleyville, TX (US)

(73) Assignee: Securus Technologies, Inc., Dallas, TX (US)

(21) Appl. No.: 14/877,045

(22) Filed: Oct. 7, 2015

(51) Int. Cl. G06Q 30/06; G06Q 20/26; G06Q 20/24; G06Q 20/16

(52) U.S. Cl. CPC G06Q 30/0607; G06Q 20/16; G06Q 20/24; G06Q 20/26

(57) ABSTRACT

A secure virtual controlled-environment facility storefront accessible by controlled-environment communication and/or media devices presents a subset of goods offered by a retailer. This subset of goods may be approved by the controlled-environment facility for purchase by a resident of the controlled-environment facility and/or the particular resident viewing the storefront. Also, consumer credit and/or debit card information the resident may use in purchase of the goods is stored and provided to the retailer in payment for resident-purchased goods. A spending limit for a particular credit or debit card may be maintained and enforced against such storefront purchases. This retailer may be an online retailer, or the subset of goods offered by the retailer may be a subset of goods offered online by a retailer and the retailer's existing packing and shipping channels may be employed.

### TECHNICAL FIELD

The present disclosure relates generally to controlled-environment facilities, more particularly to purchases by residents of controlled-environment facilities, and specifically to virtual storefronts for use by residents of controlled-environment facilities with payment for goods from the storefront using non-resident consumer cards by controlled-environment facility residents.

### BACKGROUND

According to the International Centre for Prison Studies, the United States has the highest prison population per capita in the world. In 2009, for example, 1 out of every 135 U.S. residents was incarcerated. Generally, inmates convicted of felony offenses serve long sentences in prison (e.g., federal or state prisons), whereas those convicted of misdemeanors receive shorter sentences to be served in jail (e.g., county jail). In either case, while awaiting trial, a suspect or accused may remain incarcerated. During his or her incarceration, an inmate may have opportunities to purchase consumer goods, such as via a “commissary” operation of one type or another.

Additionally, over the past several years, the sharp increase in the U.S. inmate population has not been followed by a proportional increase in the number of prison or jail staff. To the contrary, budget pressures in local, state, and federal governments have made it difficult for correctional facilities to maintain an adequate number of wardens, officers, and other administration personnel. Hence, many correctional facilities are often unable to perform investigations with respect to their own inmates.

In a controlled-environment facility, such as within a correctional facility, such as a prison or jail, controlling access, information, interaction, and/or transactions is often of particular interest. In a correctional facility in particular, safety and security is of paramount importance and, therefore, the number one job of the personnel thereof is to effectively implement controls with respect to the residents (inmates) thereof. However, such controlled-environment facilities often operate not unlike a small city in which a number of individuals work and live, thus requiring various goods and/or services associated with civilized society. Accordingly, various exchanges of information, money, goods, etcetera, may be performed in association with individuals of a controlled environment, both within the controlled-environment facility and external thereto. For example, an inmate residing in a prison facility may be allowed to place phone calls to friends and family outside of the prison facility. Likewise, an inmate may be allowed to purchase commissary items, such as through use of a prepaid account funded by friends and family, such as when visiting the prison facility or by mailing checks or money orders on behalf of an inmate. Such commissary items may include toiletries, bed linens, clothing, and food items. However, facilitating and administrating exchanges of information, money, goods, etcetera, with respect to a controlled environment facility, such in association with each of the foregoing examples, is often costly and time consuming and may even present security and safety issues. For example, controlled environment facility personnel (e.g., correctional officer) time is expended in taking orders for commissary items, verifying that individuals have sufficient funds to purchase commissary items, accepting and accounting for funds received from various individuals for the benefit of another individual to purchase commissary, reporting status of accounts and orders, etcetera. Moreover, such personnel may be called upon repeatedly to perform tasks such as responding to balance inquiries, explaining account deductions/credits, answering frequently asked questions, and/or the like. The time such controlled environment facility personnel dedicate to such tasks is both costly to the controlled environment facility and removes such personnel from other tasks, such as securing the facility and monitoring the activity of the population.

Moreover, such tasks as accomplished today are typically largely paper based and require appreciable manual processing, thereby further aggravating the directing of personnel's attention away from tasks more primary to the operation of the controlled environment facility and further adding to the costs. For example, appreciable resources are often involved in taking commissary orders, such as to provide updated item and price lists, order forms (e.g., SCANTRON forms), etcetera. The personnel that prepare the commissary packages are subject to background checks and are monitored to prevent contraband introduction into the facility in this manner. Prior to distribution, the orders are inspected by facility staff for potential contraband and sorted by housing unit. Accordingly, current processes for facilitating and administering exchanges of information, money, goods, etcetera, with respect to a controlled environment facility involve substantial expenses for consumable resources.

In addition to issues with respect to taking time and attention away from tasks of primary importance, the aforementioned exchanges may present increased safety and other issues. For example, increased contact between prison personnel and inmates can increase the danger to the prison personnel, thus interaction associated with collection of monies by prison personnel for deposit in inmate accounts can expose such personnel to claims of theft of such monies. Further, in an incarceration environment, using prison or jail personnel to retrieve account balances, and the like, is time consuming for these personnel taking time away from their primary duties and causing distractions which can present a security risk. Accordingly, inefficiencies exist with respect to the businesses and individuals conducting such exchanges associated with controlled environment facilities.

Non-residents, individuals external to a controlled environment facility, which conduct exchanges therewith are often less than satisfied with the experience. For example, depositing monies on behalf of a friend or family member residing within a controlled environment facility typically requires delivering such monies directly to the controlled environment facility or sending checks or money orders by mail. Additionally, the sending party may not be provided with any confirmation of the monies received. Even when deposits into a resident trust account using a credit or debit card is allowed, little flexibility with respect to the forms and timing of payment are afforded. Furthermore, it is typically somewhat impractical for a resident of a controlled environment facility to request account deposits from third parties, as the resident's ability to communicate with parties outside of the facility are typically restricted.

In accordance with the foregoing, controlled-environment facility residents, such as correctional facility inmates, currently purchase commissary goods from traditional commissary providers. These providers are limited in products, typically only offering generic products. Further, the ordering process is typically limited to the use of manual paper forms, such ordering, as well as distribution is typically limited, such as to one (particular) day per week. Also in accordance with the foregoing, a consumer (i.e. non-resident, such as a friend or family member of the resident) must use a credit card or cash to add money to the resident's trust account for the resident to be able to purchase commissary goods. Such a resident trust account is typically the only account that may be used by the resident to purchase commissary items.

### SUMMARY

The present invention is directed to systems and methods which provide a secure virtual controlled-environment facility storefront, wherein a controlled-environment facility management system, or the like, may select a subset of goods offered by a retailer that are approved by the controlled-environment facility for purchase by a resident of the controlled-environment facility. This retailer may be an online retailer, or the subset of goods offered by the retailer may be a subset of goods offered online by a retailer and the goods may be name-brand goods. A controlled-environment facility communication management system, or the like may present the selected subset of goods for purchase by a resident of the controlled-environment facility as a secure virtual controlled-environment facility storefront accessible by controlled-environment communication and/or media devices. A controlled-environment facility resident account management system, or the like, may store, in association with the controlled-environment facility, consumer credit and/or debit card information that the resident may use in purchase of the goods presented in the controlled-environment facility virtual storefront, and may provide the consumer credit and/or debit card information to the retailer in payment for purchased goods.

Thus, embodiments of the present systems and methods may offer a secure virtual controlled-environment facility storefront accessible by controlled-environment communication and/or media devices and present a subset of goods offered by a retailer that are approved by the controlled-environment facility for purchase by a resident of the controlled-environment facility in the controlled-environment facility virtual storefront. Also such embodiments may provide for storing consumer credit and/or debit card information the resident may use in purchase of the goods and provide such consumer credit and/or debit card information to the retailer in payment for resident-purchased goods.

In some embodiments, the controlled-environment facility resident account management system, or the like, may store a credit limit the resident may use to purchase goods from the controlled-environment facility virtual storefront using a particular consumer credit and/or debit card. Further, the controlled-environment facility resident account management system, or the like, may determine whether the purchase of goods by the resident is permitted under the credit limit, prior to providing the consumer credit and/or debit card information to the retailer in payment for purchased goods.

Also, in some embodiments the controlled-environment facility management system, or the like, may select the subset of goods offered by the retailer that are approved by the controlled-environment facility for purchase by the resident of the controlled-environment facility based upon an identity of a particular resident viewing the storefront on a controlled-environment communication and/or media device and based upon what goods the particular resident is allowed to purchase. Additionally or alternatively, the controlled-environment facility management system, or the like, may select the subset of goods offered by the retailer that are approved by the controlled-environment facility for purchase by the resident of the controlled-environment facility based upon an identity of a particular resident associated the controlled-environment communication and/or media device being used to view the storefront and what goods the particular resident is allowed to purchase.

The retailer may package and ship purchased goods via existing anonymous packaging and shipping channels employed by the retailer, in accordance with embodiments of the present systems and methods.

In various embodiments, one or more of the techniques described herein may be performed by one or more computer systems. In other various embodiments, a tangible computer-readable storage medium may have program instructions stored thereon that, upon execution by one or more computer systems, cause the one or more computer systems to execute one or more operations disclosed herein. In yet other various embodiments, one or more systems may each include at least one processor and memory coupled to the processor(s), wherein the memory is configured to store program instructions executable by the processor(s) to cause the system(s) to execute one or more operations disclosed herein.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Having thus described the invention in general terms, reference will now be made to the accompanying drawings, which are not necessarily drawn to scale, and wherein:

FIG. 1 is a diagrammatic illustration of an example environment, wherein an example embodiment of the present virtual storefronts for controlled-environment facilities may be deployed within a controlled-environment facility, in accordance with some embodiments;

FIG. 2 is a diagrammatic illustration of an example environment, wherein an example embodiment of the present systems and methods for virtual storefronts for controlled-environment facilities may be implemented by a centralized provider, external to a controlled-environment facility, in accordance with some embodiments;

FIG. 3 is a diagrammatic illustration of an example of an intelligent facility communication device, according to some embodiments;

FIG. 4 is a diagrammatic illustration of an example intelligent resident communication and/or media device, according to some embodiments of the present systems and methods;

FIG. 5 is a flowchart of an example process implementation for providing a secure virtual controlled-environment facility storefront and providing payment for goods from the storefront using non-resident consumer cards by residents of the controlled-environment facility, in accordance with some embodiments;

FIG. 6 is a block diagram of a computer system, device, station, or terminal configured to implement various techniques disclosed herein, according to some embodiments.

While this specification provides several embodiments and illustrative drawings, a person of ordinary skill in the art will recognize that the present specification is not limited only to the embodiments or drawings described. It should be understood that the drawings and detailed description are not intended to limit the specification to the particular form disclosed, but, on the contrary, the intention is to cover all modifications, equivalents and alternatives falling within the spirit and scope of the claims. As used herein, the word “may” is meant to convey a permissive sense (i.e., meaning “having the potential to”), rather than a mandatory sense (i.e., meaning “must”). Similarly, the words “include,” “including,” and “includes” mean “including, but not limited to.”

### DETAILED DESCRIPTION

The invention will now be described more fully hereinafter with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. One skilled in the art may be able to use the various embodiments of the invention.

For example, various types of controlled-environment facilities are present in today's society, and persons may be voluntary or involuntary residents of such facilities, whether temporarily or permanently. Examples of controlled-environment facilities may include correctional institutions (e.g., municipal jails, county jails, state prisons, federal prisons, military stockades, juvenile facilities, detention camps, home incarceration environments, etc.), healthcare facilities (e.g., hospitals, nursing homes, mental health facilities, rehabilitation facilities, such as drug and alcohol rehabilitation facilities, etc.), restricted living quarters (e.g., hotels, resorts, camps, dormitories, barracks, etc.), and the like. For convenience of explanation, various examples discussed herein are presented in the context of correctional facilities, or the like. For instance, in some of the embodiments discussed below, a controlled-environment facility may be referred to as a correctional facility, jail or prison, and its residents may be referred to as inmates, arrestees, or detainees. It should be understood, however, that the systems and methods described herein may be similarly applicable to other types of controlled-environment facilities and their respective residents (e.g., a hospital and its patients, a school dormitory and its students, etc.).

The present systems and methods relate generally to such controlled-environment facilities, more particularly to purchases by residents of controlled-environment facilities, and specifically to virtual storefronts for controlled-environment facilities with payment for goods from the storefront using non-resident consumer cards by controlled-environment facility residents. In accordance with embodiments of the present systems and methods, a secure virtual controlled-environment facility storefront accessible by controlled-environment communication and/or media devices presents a subset of goods offered by a retailer. This subset of goods may be approved by the controlled-environment facility for purchase by a resident of the controlled-environment facility and/or the particular resident viewing the storefront. Also, consumer credit and/or debit card information the resident may use in purchase of the goods is stored and provided to the retailer in payment for resident-purchased goods. A credit limit and/or other purchasing limits for a particular credit or debit card may be maintained and enforced against such storefront purchases. This retailer may be an online retailer, or the subset of goods offered by the retailer may be a subset of goods offered online by a retailer and the retailer's existing packing and shipping channels may be employed.

Hence, embodiments of the present systems and methods are directed to providing a secure, consumer environment, virtual storefront and consumer payment card holding to the benefit of controlled-environment facility residents. Thus, in accordance with embodiments of the present systems and methods, a secure virtual storefront, may display only certain approved goods, and may be partnered with a consumer retail company. In accordance with such embodiments, a secure virtual storefront may be provided where certain name-brand (or generic) goods are made available to residents to purchase through a controlled environment facility kiosk, a resident's controlled-environment facility approved media and/or communications device, resident-accessible website, etcetera. Such embodiments of the present systems and methods may address product availability problems present with existing commissary systems, which typically only offer generic products, by making name-brand products available. Further, such embodiments may address distribution problems by utilizing existing distribution methods employed by the consumer retail company. Such embodiments may further address ordering process issues (e.g. use of paper forms, and the handling in of such forms) through use of hardware, software, network infrastructure and the like which may also serve to provide controlled-environment facility communications (and distribution of media). Such controlled-environment facility communications (and media) hardware, software, network infrastructure and the like, may be collocated with a subject controlled-environment facility, decentralized, with respect to the subject controlled-environment facility, centralized external to the subject controlled-environment facility, etcetera.

As noted, commissary may traditionally only be offered once a week or the like. Also, it typically takes about a week for ordered goods to be delivered. Thus, when a resident taken into a controlled-environment facility (such as when an inmate is booked or transferred into a correctional facility) they may miss the opportunity to place a commissary order, so it may be about two weeks until they can obtain commissary goods. Additionally, scheduling or the like may make it difficult for a resident to place a commissary order (using a paper form), and relatively short term residents may miss out on an opportunity to place orders, or it may be impossible for them to place orders due to delivery possibly being after the end of their stay. However, advantageously, in accordance with embodiments of the present systems and methods, a order may be placed at any time, using a controlled-environment facility kiosk, a controlled-environment facility approved resident media and/or communications device, resident-accessible website, etcetera.

The goods offered via the storefront may be limited, for example, a subset of goods normally offered by the consumer retail company, selected to be appropriate for the resident (or the residents, generally) of the controlled-environment facility. That is, the offerings of the consumer retail company may be filtered in accordance with embodiments of the present systems and methods. Use of a consumer retail company for order fulfillment provides anonymity to avoid security issues.

Further, in accordance with embodiments of the present systems and methods, consumers outside the controlled-environment facility (i.e. non-residents (e.g. friends and family members of a resident)) may be enabled to associate one or more credit and/or debit cards to a resident and create a customized spending limit. So, instead of funding a commissary account where funds are transferred to the resident (i.e. a resident trust account), this credit card association allows the consumer to remain in control of their funds while also allowing the resident to purchase goods, including name-brand goods, in accordance with embodiments of the present systems and methods. In accordance with various embodiments of the present systems and methods, card information is stored on file with parameters identifying the consumer nonresident card holder, spending limits and the particular resident that may use the card. Hence, a consumer may, in accordance with various embodiments, be enabled to put a number of cards on a resident's account, with different credit limits for the resident to use. Also, embodiments of the present systems and methods may provide an ability for a consumer to associate their credit/debit card(s) to any number of residents, with a spending limit allowing each resident to purchase goods using an assigned spending limit. Likewise, these or other embodiments may enable a number of consumers (e.g. various family members of a resident) to associate their cards to a particular resident, to allow the resident to have a number of integrated spending limits. The credit limit may be based not only on a total limit amount, but also on a limit that may be used for a single transaction, a limit that may be used for purchase of a single item, a limit that may be used in a given time frame, and/or the like. Further, rules that limit resident purchases and determine what they can and cannot purchase with the credit may be additionally or alternatively employed in accordance with embodiments of the present systems and methods.

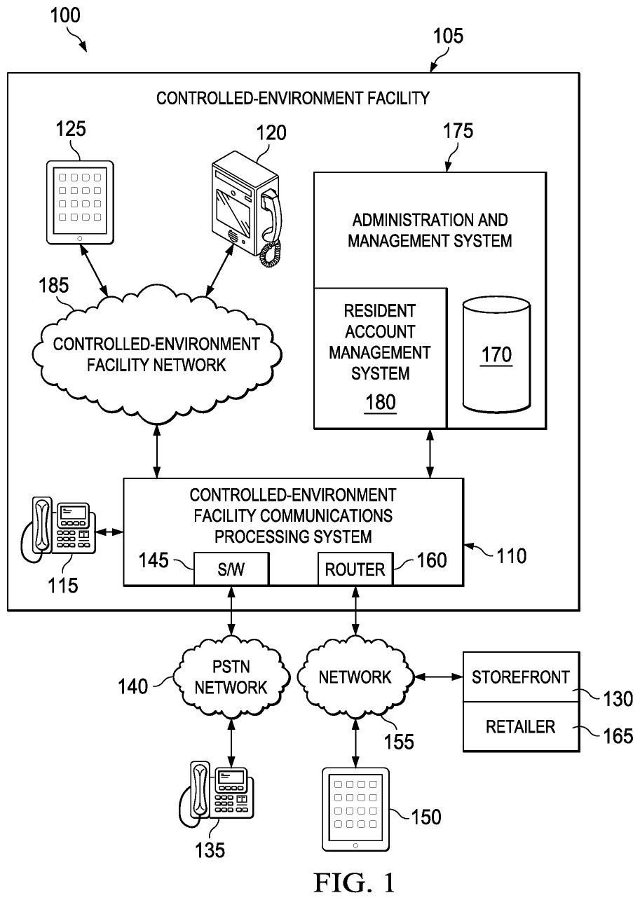

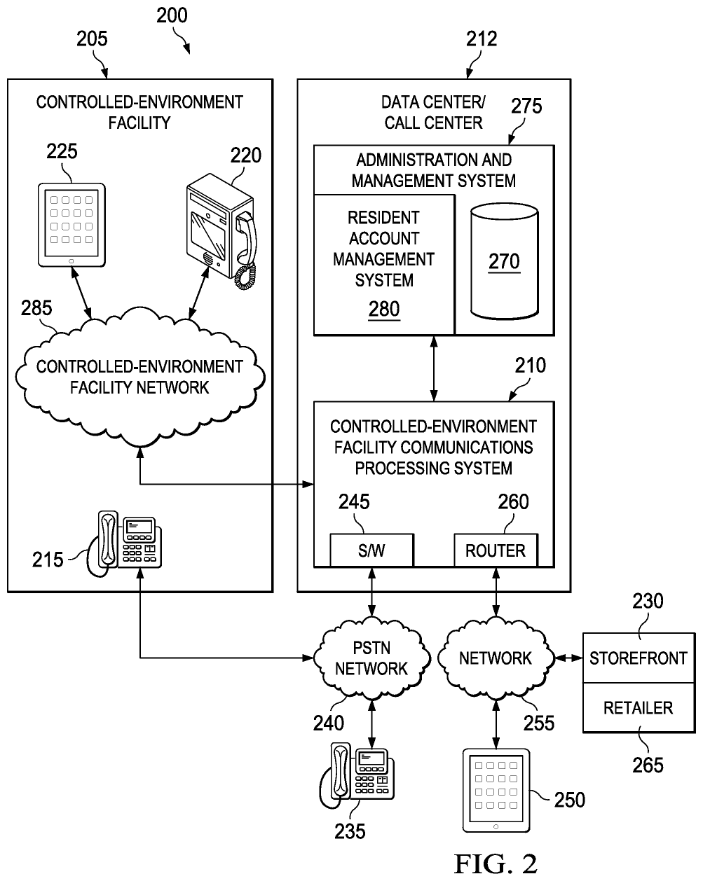

FIG. 1 is a diagrammatic illustration of an example environment 100, wherein an example embodiment of the present virtual storefronts for controlled-environment facilities may be deployed within controlled-environment facility 105, in accordance with some embodiments. Communication processing system 110 may provide telephone services, videoconferencing, online chat, and other communication services to residents of controlled-environment facility 105. In some cases, such as illustrated, communication processing system 110 may be co-located with controlled-environment facility 105. Alternatively, communication processing system 110 may be centrally or remotely located with respect to one or more controlled-environment facilities and/or may provide communication services to multiple controlled-environment facilities (such as discussed below with respect to FIG. 2). More generally, however, it should be noted that communication processing system 110 may assume a variety of forms, and may be configured to serve a variety of facilities and/or users, whether within or outside of a controlled-environment facility.

Residents may use more-or-less conventional telephones 115 to access certain communication services. However, in accordance with embodiments of the present systems and methods, residents may also use a controlled-environment communication and/or media device or the like. For example, a resident may use a video communication device 120, or the like, to place voice calls, as well as for video communication. Such a video communication device may be referred to as an Intelligent Facility Device (IFD), which may be a videophone particularly adapted for use in a controlled-environment facility. Generally speaking, multiple video communication devices/IFDs 120 are disposed in a controlled-environment facility, and may be disposed in a visitation room, in a pod, as part of a kiosk, etcetera. Additionally or alternatively, in accordance with embodiments of the present systems and methods, personal computer wireless devices, such as a tablet computing device or smartphone (125), which may have been adapted and/or approved for use in controlled-environment facility, may be used by controlled-environment facility residents for communication. Such a device may be referred to as an Intelligent Inmate Device (IID) in a correctional institution environment, and/or an Intelligent Resident Device (IRD), or the like, in controlled-environment facilities in general. As will be appreciated, IFD 120, IRD 125, or other similar devices have video conferencing capabilities, or the like, to enable a party to participate in video communication sessions with other call parties, such as non-residents of the controlled-environment facility, via video communication, secure online chat, etcetera. Regardless, IFDs, IIDs, IRDs, etcetera, may be generally referred to herein as a “controlled-environment communication and/or media device,” or the like.

In accordance with embodiments of the present systems and methods, controlled-environment communication and/or media devices (120 and 125) may be used to place storefront orders and such orders, such as via secure virtual controlled-environment facility storefront 130 and provide payment for goods from the storefront using non-resident consumer cards. That is, an IFD or IRD can be used to log onto a website, or the like, to access controlled-environment facility virtual storefront 130 provided by a retailer, such as an online retailer. Thereby, an IFD or IRD can be used as a point of sale for goods, via such a secure controlled-environment facility virtual storefront, and payment using one or more on-file consumer credit/debit card spending limits may also be implemented using the ordering IFD or IRD, hence, in accordance with embodiments of the present systems and methods, providing paperless transactions.

In various embodiments, video communication devices, IFDs 120, may be implemented as a computer-based system. For example, as discussed in greater detail below, each of IFD 120 may include a display, camera, and handset. The display may be any suitable electronic display such as, for example, a Liquid Crystal Display (LCD), a touchscreen display (e.g., resistive, capacitive, etcetera), or the like, whereas the camera may be any suitable imaging device such as, for instance, a video camera or webcam equipped with Charge-Coupled Devices (CCDs), Complementary Metal-Oxide-Semiconductor (CMOS) active pixel sensors, etcetera. A handset may be similar to a traditional telephone handset including an earpiece portion (with a loudspeaker), a handle portion, and a mouthpiece portion (with a microphone). During a video communication session, IFD 120 may be configured to capture a video image of a resident to be transmitted to a non-resident using the camera, and to display a video image of the non-resident to the resident using the display. IFD 120 may also be configured to capture an audio signal from the resident to be transmitted to a non-resident using the mouthpiece portion of the handset, and to provide an audio signal from the non-resident to the resident using the earpiece portion of the handset. Additionally or alternatively, audio received from the non-resident may be reproduced via a loudspeaker, and audio provided by the resident may be captured via a microphone. In some cases, IFD 120 may assume the form of any computer, tablet computer, smart phone, etcetera, or any other consumer device or appliance with videoconferencing capabilities. For example, in a correctional facility environment a tablet computing device may be mounted on a wall, in a hardened case, as a video communication device or IFD.

IRDs 125 may be a personal controlled-environment facility resident communication and/or media device, such as a tablet computing devices, smartphones, media players, or the like adapted and/or approved for use by residents of the controlled-environment facility (within the controlled-environment facility). Each IRD 125 may be particularly adapted for use in a controlled-environment. For example, in a correctional institution, jail, or the like, such an IRD, or IID, may have a specially adapted operating system and/or may be “stripped-down,” particularly from the standpoint of what apps and/or hardware are provided or allowed on IRD 125, and/or connectivity afforded such a IRD. For example, such an IRD may employ an operating system kernel such as one based upon an open source platform such as the CyanogenMod-based operating system, which may be built for use in such an IRD in a controlled-environment facility. As a further example, the IRD may be adapted to only connect to a network provided by the controlled-environment facility, and/or in only certain locations, within the controlled-environment facility, such as may be controlled by availability of Wi-Fi access, or the like, only being available in certain areas. That is, for example, where streaming and/or downloading may be compartmentalized, leveraging the structure of the controlled-environment facility, for example, limiting the availability of a Wi-Fi signal, providing the stream through the placement of wireless access points, antenna directionality of such wireless access points, and/or the like.

In various embodiments, to access communication services, a resident may initiate telephone services by lifting the receiver on telephone 115 or IFD 120, and/or otherwise initiating a call, such as by launching a communications application program (app) on IRD 125. At which time, the resident may be prompted to provide a personal identification number (PIN), other identifying information or biometrics. An interactive voice response (IVR) unit (not shown, but which may be integrated into communication processing system 110) may generate and play a prompt, or other messages, to the resident on device 115, 120 or 125. Under the control of communication processing system 110, devices 115, 120 and 125 may be capable of connecting to a non-resident's (i.e., a person not incarcerated or otherwise committed to a controlled-environment facility) telephone 135 across a publicly switched telephone network (PSTN) 140. For example, telephone 140 may be located at a non-resident's home or office, at a resident visitation center, etcetera. Switch 145, in communication processing system 110, may be used to connect calls across PSTN 140. Additionally or alternatively, the non-resident may communicate using device 150, which may be a mobile phone, tablet computing device, personal computer, or the like, which may be connected through an Integrated Services Digital Network (ISDN), Voice-over-IP (VoIP), or packet data network (such as, for example, the Internet), a wireless communications network, or the like 155. Router 160 of communication processing system 110 is used to route data packets associated with a call connection to device 150. For example, a non-resident party may have a device 150 with a built-in front-facing camera, or the like, and an integrated display (e.g., a smart phone, tablet, etcetera, as illustrated), a personal computer with a webcam, etcetera. A network connection between the parties may be established and supported by an organization or commercial service that provides computer services and software for use in telecommunications and/or VOIP, such as SKYPE®. Additionally or alternatively, the correctional facility and/or the destination may use videoconferencing equipment compatible with ITU H.323, H.320, H.264, and/or V.80, or other suitable standards.

Further, communication out of facility 105 may be directed to storefront vendor/retailer 165 that supplies goods to residents of controlled-environment facility 105, such as, at least in part, through secure virtual controlled-environment facility storefront 130. These communications may take the form of resident orders, which may be paid for using non-resident consumer cards by the resident of controlled-environment facility 105.

In addition to providing certain visitation and communication operations, communication processing system 110 may attempt to ensure that a resident's calls, video conferences, online chats, etcetera, are performed only with non-residents whose identities, devices, email addresses, phone numbers, etcetera, are listed in that resident's Pre-Approved Contact (PAC) list. Each resident's PAC list may be stored, for example, in database 170 maintained by controlled-environment Administration and Management System (AMS) 175. In addition to PAC list(s), AMS 175 may also store Resident Profile Data (RPD), as well as communication and/or visitation rules applicable to each resident. As an example, in the context of a correctional facility, AMS 175 may be referred to as a Jail Management System (JMS). Within the AMS or JMS 175, database 170 may include information such as balances for resident trust, commissary and calling accounts; purchasing history, trial schedule; conviction data; criminal record; sentencing data, such as time served, time remaining to be served, and release date; cell and cellmate assignments; resident restrictions and warnings; commissary and/or storefront order history; telephone call history; call recordings; known or suspected gang or criminal affiliations; known or suspected affiliates, accomplices, or gang members; and any other information that may be relevant or useful to correctional facility staff to house and maintain residents.

Controlled-environment facility resident account management system 180, which may be a separate system, or which may be a part or function of AMS 175, as illustrated, may maintain resident accounts to the benefit of the respective resident, such as resident communications accounts, trust accounts, or the like. In accordance with embodiments of the present systems and methods, resident account management system 180, or similar functionality, may maintain consumer credit and/or debit card information, such as card account number information, expiration date, security code, card-holder's address, and/or the like. This stored consumer credit and/or debit card information may (also) include one or more spending limits on purchases by the resident from secure controlled-environment facility virtual storefront 130.

In some implementations, communication processing system 110 may be configured to perform video communication monitoring operations configured to monitor and or record video communication sessions (e.g., as electronic video files). In scenarios where communication processing system 110 is located within the controlled-environment facility, it may have direct access to AMS or JMS 175. In other embodiments, however, communication processing system 110 may be located remotely with respect to the controlled-environment facility, and access to AMS or JMS 175 may be obtained via a computer network such as, for example, network 155 and/or 185.

FIG. 2 is a diagrammatic illustration of example environment 200, wherein an example embodiment of the present virtual storefronts for controlled-environment facilities may be implemented by a centralized provider, external to controlled-environment facility 205, in accordance with some embodiments. Therein, communication processing system 210, which may be housed in a datacenter or call center 212 may provide telephone services, videoconferencing, online chat, and other communication services to residents of one or more controlled-environment facilities, such as illustrated controlled-environment facility 205. Thus, in FIG. 2 communication system 210 is centrally and remotely located with respect to one or more controlled-environment facilities and/or may provide communication services to multiple controlled-environment facilities.

Residents may use more-or-less conventional telephones 215 to access certain communication services. Also, in accordance with embodiments of the present systems and methods, residents may use a controlled-environment communication and/or media device or the like, such as video communication device (IFD) 220, or the like, to place voice calls, as well as for video communication. Again, multiple video communication devices/IFDs 220 are disposed in a controlled-environment facility, and may be disposed in a visitation room, in a pod, as part of a kiosk, etcetera. Additionally or alternatively, in accordance with embodiments of the present systems and methods, personal computer wireless devices, such as a tablet computing device or smartphone (IRD or IID 225), which may have been adapted and/or approved for use in controlled-environment facility, may be used by controlled-environment facility residents for communication.

In accordance with embodiments of the present systems and methods shown in FIG. 2, controlled-environment communication and/or media devices (220 and 225) may also be used to place orders and such orders, such as via secure virtual controlled-environment facility storefront 230 point of sale and provide payment for goods from the storefront using non-resident consumer cards, thereby providing paperless transactions.

Under the control of communication processing system 210, devices 215, 220 and 225 may be capable of connecting to a non-resident's (i.e., a person not incarcerated or otherwise committed to a controlled-environment facility) telephone 235 across a publicly switched telephone network (PSTN) 240. Switch 245, in communication processing system 210, may be used to connect calls across PSTN 240. Additionally or alternatively, the non-resident may communicate using device 250, which may be a mobile phone, tablet computing device, personal computer, or the like, which may be connected through an Integrated Services Digital Network (ISDN), Voice-over-IP (VoIP), or packet data network (such as, for example, the Internet), a wireless communications network, or the like 255. Router 260 of communication processing system 210 is used to route data packets associated with a call connection to device 250.

As noted, in addition to conventional voice and/or video communication out of facility 205, communications may be directed to a vendor/retailer 265 that supplies goods to residents of controlled-environment facility 205, such as, at least in part, through secure controlled-environment facility virtual storefront 230. These communications may take the form of resident orders, which may be paid for using non-resident consumer cards by the resident of controlled-environment facility 205.

Again, in addition to providing certain visitation and communication operations, communication processing system 210 may also attempt to ensure that a resident's calls, video conferences, online chats, etcetera, are performed only with non-residents whose identities, devices, email addresses, phone numbers, etcetera, are listed in that resident's Pre-Approved Contact (PAC) list, such as may be stored in database 270 maintained by controlled-environment Administration and Management System (AMS) 275. AMS 275 may also store Resident Profile Data (RPD), as well as communication and/or visitation rules applicable to each resident. In the context of a correctional facility, AMS 275 may be referred to as a Jail Management System (JMS) and may be collocated with the managed facility, or may be deployed from a datacenter or the like as illustrated in FIG. 2. Within the AMS or JMS 275, database 270 may also include information such as balances for resident trust, commissary and calling accounts; purchase history, trial schedule; conviction data; criminal record; sentencing data, such as time served, time remaining to be served, and release date; cell and cellmate assignments; resident restrictions and warnings; commissary and/or storefront order history; telephone call history; call recordings; known or suspected gang or criminal affiliations; known or suspected affiliates, accomplices, or gang members; and any other information that may be relevant or useful to correctional facility staff to house and maintain residents.

Controlled-environment facility resident account management system 280, which may be a separate system, or which may be a part or function of AMS 275, as illustrated, may maintain resident accounts to the benefit of the respective resident, such as resident communications accounts, trust accounts, or the like. In accordance with embodiments of the present systems and methods, resident account management system 280, or similar functionality, may maintain consumer credit and/or debit card information, such as card account number information, expiration date security code, card-holder's address, and/or the like. This stored consumer credit and/or debit card information may (also) include a credit limit the resident may use, and/or other limits, on the purchase of goods from secure virtual controlled-environment facility storefront 230. Such information may be exchanged via networks 255 and/or 285.

As noted, traditionally, jails, prisons, holding cells, lock-ups or other controlled-environment facilities often provide commissary services that allow prisoners or inmates to purchase food, tobacco products, toiletries, and other items. In order to use the commissary services, the prisoner, inmate, detainee or other resident must traditionally open and fund a commissary account. Funds may be added to such commissary accounts by the detainee or by their lawyer, family members or friends. A jail management system (AMS 175, 275) may be used to manage the commissary services. For example, commissary fund data for individual prisoners may be stored to a jail management system database (170, 270), or to a separate database. Additionally, the commissary fund data may be associated with or linked to data files related to the prisoner.

However, in accordance with embodiments of the present systems and methods, a secure controlled-environment facility virtual storefront system may be provided by controlled-environment facility administration and management system 175, 275, or the like, selecting a subset of goods offered by retailer 265 to be presented as the storefront. Retailer 265 may be an online retailer, the subset of goods offered by retailer 265 may be a subset of goods offered online by retailer 265, etcetera. These goods may be goods approved by the controlled-environment facility for purchase by a resident of the controlled-environment facility, or at least not forbidden from being purchased by facility residents. Controlled-environment facility administration and management system 175, 275, or the like, may select the subset of goods offered by the retailer to be presented as the storefront to a particular resident based upon an identity of the particular resident viewing the storefront on a controlled-environment communication and/or media device and what goods the particular resident is allowed (or at least not forbidden) to purchase. Additionally or alternatively, controlled-environment facility management system 175, 275, or the like may select the subset of goods offered by the a retailer to be presented as the storefront to a particular resident based upon an identity of a particular resident associated the particular controlled-environment communication and/or media device (120, 125, 220 and/or 225) being used to view the storefront and what goods the particular resident is allowed (or at least not forbidden) to purchase. Regardless, preferably, these goods are name-brand goods, rather than generic goods traditionally offered by controlled-environment facility commissary systems.

Further, in providing such storefront system embodiments, controlled-environment facility communication processing system 110, 210, or the like, may present the subset of goods offered by retailer 265 that are selected by administration and management system 175 or 275 and approved (or at least not forbidden) by the controlled-environment facility for purchase by a resident of the controlled-environment facility as the secure virtual controlled-environment facility storefront, which may only be accessible by controlled-environment communication and/or media devices 120, 125, 220 and/or 225, via a secure website, or the like. The storefront presented may be hosted by servers of retailer 265 (as illustrated in FIGS. 1 and 2), controlled-environment facility communication processing system 110 or 210, AMS 175 or 275, by a separate server, or the like.

Also in providing these storefront system embodiments, controlled-environment facility resident account management system 180, 280, or the like, may store, such as in association with controlled-environment facility 105 or 205, consumer credit and/or debit card information that the resident may use in purchase of the goods offered by retailer 265 through the virtual storefront. Upon purchase of such goods, resident account management system 180, 280, or the like, may provide the consumer credit and/or debit card information to retailer 265 in payment for the purchased goods. In various system and method embodiments, controlled-environment facility resident account management system 180, 280, or the like, may also store a credit limit the resident may use to purchase goods from the secure controlled-environment facility virtual storefront using a particular consumer credit and/or debit card. This credit limit may be based not only on a total amount the resident is allowed to pend from the credit or debit card, but also may limit the amount that can be spent in a single transaction, limit the amount that can be used for purchase of a single item, limit the amount that can be spent in a given time frame (e.g. per day, per week, per month, per year, etc.), and/or the like. Additionally or alternatively, rules that limit resident purchases and determine what they can and cannot purchase with the credit may be stored, such as by controlled-environment facility resident account management system 180, 280, or the like in accordance with various embodiments of the present systems and methods. Further, resident account management system 180, 280, or the like, may, prior to providing the consumer credit and/or debit card information to retailer 265 in payment for purchased goods, determine whether the purchase of goods by the resident is permitted under such spending limits.

Also, in accordance with such storefront system embodiments, retailer 265 may package and ship purchased goods via (existing) anonymous packaging and shipping channels employed by retailer 265. This packaging and shipping may be anonymous in that if a large online retailer is used, the volume of the existing packaging operations of a large online retailer (such as AMAZON®, WAL-MART®, or the like) and their use of a large shipping entity (such as FEDEX®, UPS®, the postal service, or the like) may provide this anonymity. If smaller retailer is performing the packaging or shipping other manual or automated processes may be implemented to insure anonymity

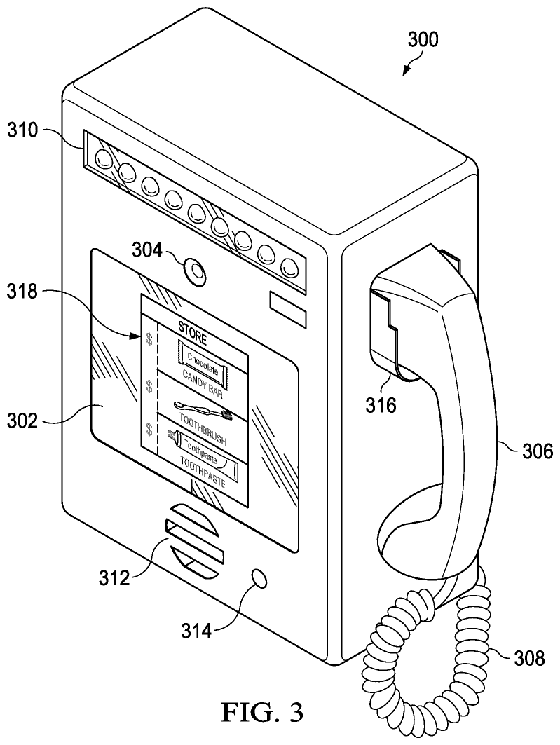

FIG. 3 is a diagrammatic illustration of example intelligent facility communication device, IFD 300 (which generally corresponds to IFDs 120 and 220 of FIGS. 1 and 2), according to some embodiments. In some implementations, IFD 300 may be located in a pod, which is a separate and self-contained housing unit within a correctional facility designed to hold a number of inmates (e.g., ˜12 to 50 prisoners). A small number of prison officers (e.g., ˜2 or 3), and sometimes a single officer or other facility personnel, supervise each pod. Each pod may contain tiers of cells arranged around a central control station or desk from which a single officer can monitor all the cells and the entire pod, control cell doors, and communicate with the rest of the inmates. Additionally or alternatively, IFD 300 may be disposed in a visitation area of the correctional facility. In other embodiments, IFD 300 may be disposed outside of the correctional facility or within a sleeping area, such as in a cell.

As illustrated, device 300 includes display 302, camera 304, and handset 306 coupled to device 300 via wire 308. Display 302 may be any suitable electronic display such as, for example, a Liquid Crystal Display (LCD), a touchscreen display (e.g., resistive, capacitive, etcetera), or the like, whereas camera 304 may be any suitable imaging device such as, for instance, a video camera or webcam equipped with Charge-Coupled Devices (CCDs), Complementary Metal-Oxide-Semiconductor (CMOS) active pixel sensors, etcetera. Some IFDs may employ light sources for enabling capture of conventional images and/or video, such as light module 310. Handset 306 may be similar to a traditional telephone handset including an earpiece portion (with a loudspeaker), a handle portion, and a mouthpiece portion (with a microphone).

During a video visitation session, IFD 300 may be configured to capture a video image of an inmate to be transmitted to a non-resident using camera 304, and to display a video image of the non-resident to the inmate using display 302. IFD 300 may also be configured to capture an audio signal from the inmate to be transmitted to the non-resident using the mouthpiece portion of handset 306, and to provide an audio signal from the non-resident to the inmate using the earpiece portion of handset 306. Additionally or alternatively, audio received from the non-resident may be reproduced via loudspeaker 312, and audio provided by the inmate may be captured via microphone 314. In some embodiments, handset holder or holster 316 may be configured to allow a user to securely rest handset 306 against device 300 (e.g., in the “on hook” position) when device 300 is not in use. Furthermore, handset holder 316 may include a mechanical or electromechanical switch or sensor (not shown) that senses when handset 306 is its not resting against it (e.g. in the “off hook” position).

It should be noted that, outside of correctional facilities, IFD 300 might assume the form of any computer, tablet computer, smart phone, etcetera, or any other consumer device or appliance with videoconferencing capabilities. Meanwhile, in the context of correctional facilities, IFD 300 may include one or more tampering/impact resistant or hardened elements configured to protect them from vandalism or otherwise destructive acts. For example, one or more of elements 302 through 314 may be protected by a transparent plastic or thermoplastic (e.g., Plexiglas, etcetera) material.

In addition video and/or audio communications IFD 300 may also provide an interface that a resident may use for various purposes, such as ordering goods or other services. In accordance with embodiments of the present systems and methods and as discussed in greater detail above and below, a resident may view secure virtual controlled-environment facility storefront 318, place an order (such as by using touch screen 302) and provide payment for goods from the storefront using (a) non-resident consumer card(s), on IFD 300.

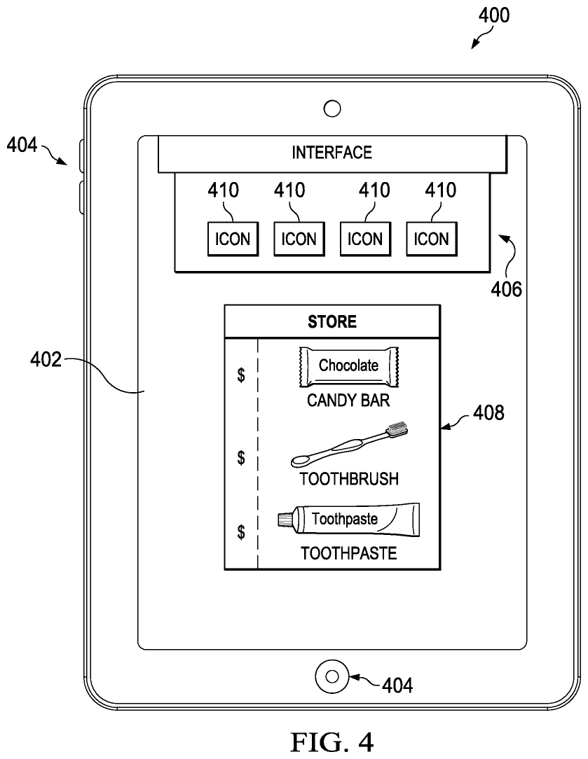

FIG. 4 is a diagrammatic illustration of example intelligent resident (communication and/or media) device 400 (which generally corresponds to IRD/IIDs 125 and 225 of FIGS. 1 and 2), according to some embodiments of the present systems and methods. IRD 400 includes touchscreen 402 and one or more hardware buttons 404. Interface 406, or the like, may provide access to a number of apps such as a virtual storefront app and/or a web browser, which may display secure virtual controlled-environment facility storefront 408, shown open in FIG. 4. For example, apps available for use by a resident of the controlled-environment facility who is operating the controlled-environment communication and/or media device may be presented via the controlled-environment facility resident interface at 406, such as via icons 410. A similar interface may be available on IFD 300. Alternatively, or additionally, goods and/or services ordering, such as in accordance with embodiments of the present systems and methods, may be incorporated into interface 406 itself. In accordance with embodiments of the present systems and methods and as discussed in greater detail above and below, a resident may place a order on IRD 400, such as through a storefront app, web browser, and/or the like, via secure virtual controlled-environment facility storefront 408 and providing payment for such goods from the storefront with (a) non-resident consumer card(s), using touch screen 402.

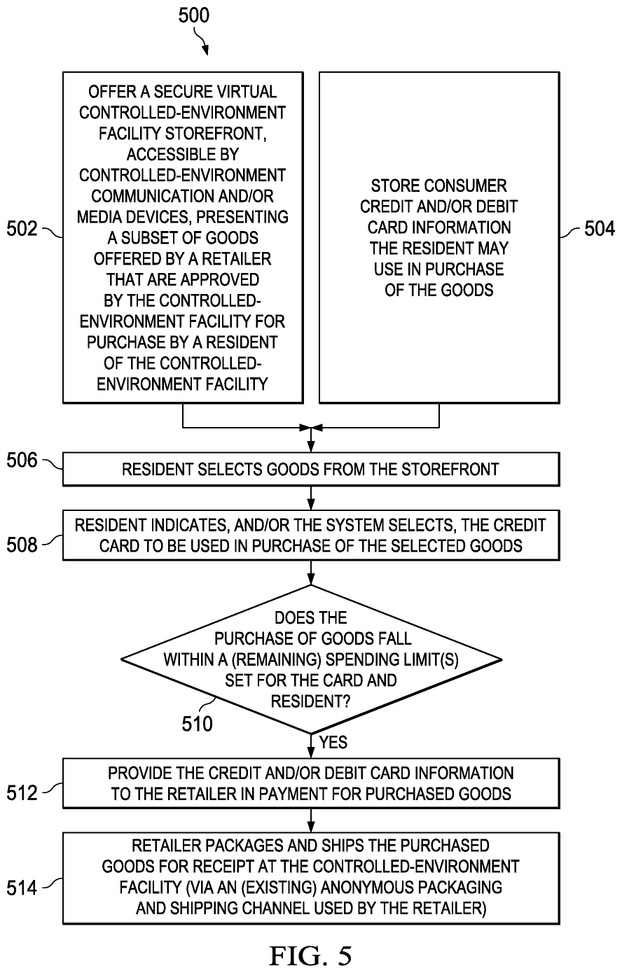

FIG. 5 is a flowchart of example process implementation 500 for providing a secure virtual controlled-environment facility storefront (130 and/or 230) and providing payment for goods from the storefront using non-resident consumer cards by residents of the controlled-environment facility, in accordance with some embodiments. Implementation 500 may start at 502, through display of a subset of goods offered by a retailer that are approved by the controlled-environment facility for purchase by a resident of the controlled-environment facility. The retailer may be an online retailer and/or the subset of goods offered by the retailer may be a subset of goods offered online by the retailer. These goods may be displayed so as to provide a secure virtual controlled-environment facility storefront, which may only be accessible by controlled-environment facility resident communication and/or media devices (125, 225, 400), controlled-environment facility/or accessible by communication and/or media stations (such as IFD 120, 220, 300 and/or kiosks), other controlled-environment communication and/or media devices, and/or the like. The goods offered by the retailer that are approved by the controlled-environment facility for purchase by a resident of the controlled-environment facility that are presented to a particular resident may be goods offered by that retailer that are approved by the controlled-environment facility for purchase by that particular resident, as identified using log-on information for the resident and/or identification of the controlled-environment communication and/or media device being used to access the storefront. These goods may be name-brand goods, as opposed to the generic goods typically offered via controlled-environment facility commissary systems.

Meanwhile, consumer credit and/or debit card information, such as card account number information, expiration date, security code, card-holder's address, and/or the like, may be stored at 504, in association with the controlled-environment facility (such as in AMS 175, 275 such as by resident account management system 180, 280). The consumer credit and/or debit card information stored at 504 may (also) include a credit limit the resident may use to purchase goods from the secure virtual controlled-environment facility storefront. Such a credit limit may be based on a total limit amount the resident is allowed to spend using the credit or debit card. Further, or alternatively, the limit may be a limit on the amount that can be used for a single transaction, a limit on the amount that can be used for purchase of a single item, a time frame limit on a total amount spent (e.g. a fixed per day, per week, per moth, per year, etc. limit or limits), and/or the like. Additionally or alternatively, rules that limit resident purchases and determine what they can and cannot purchase with the credit or debit card may be stored, such as at 504, in accordance with various implementations of the present systems and methods. For example, such rules may allow only healthy food to be purchased using the credit or debit card, or a credit limit could be designated for purchase of a particular item (such as, by way of example, an IRD/IIDs 125 or 225 for use in video visitations with consumer card hold, family members such the resident's child(ren), or the like).

In accordance with storage of credit card information at 504, a consumer may enter credit card information, select the resident, establish a spending limit, which may be per day, per transaction, per card, per inmate, per category of items etcetera, via a website. As noted, the consumer may make more than one credit or debit card available to the resident; the consumer may make one or more cards available to use by more than one resident; more than one consumer may each make (a) credit and/or debit card(s) available to a resident; etcetera. Further, the credit card holder may exercise control over the card after allowing use by a resident, such by removing permission for the resident to use the card, changing the credit limit, and/or the like. In accordance with embodiments of the present systems and methods, the card holder my be offered an opportunity to “top-up” the resident's spending limit, such as when the resident is approaching the spending limit. This top-up offer may be sent to the consumer via email, may be presented during a communication with the resident (or another resident), when the consumer logs on to the aforementioned website, and/or in other fashions. Further, in accordance with embodiments of the present systems and methods, notifications may be sent to the non-resident consumer on particular holidays, or the like, such as birthdays, Christmas, etc., with an option to add more credit to the resident's credit limit.

The resident may log into the storefront using a controlled-environment communication and/or media device and identification information, which may include a Personal Identification Number (PIN) biometric identification, and/or the like. Once logged on the resident may, at 506, select goods from the storefront and the credit card information stored at 504 may be used by the resident at 508 in an effort to purchase of the selected goods. In accordance with various alternative embodiments of the present systems and methods, the card to be used may be selected by the system, such as, by the resident account management system (180, 280) or at least an initial (default) selection that the resident may be able to change may be made by the system.

A determination may be made at 510 whether the purchase of goods by the resident is permitted under the credit limit, prior to providing other consumer credit and/or debit card information to the retailer in payment for purchased goods. Upon a determination at 510, that sufficient credit limit remains with respect to the credit/debit card(s) the resident is using for purchase of the goods, the consumer credit and/or debit card information may be provided to the retailer (such as by AMS 175, 275, for example, through resident account management system 180, 280) at 512, in payment for the purchased goods.

At 514, the purchased goods may be packaged and shipped by the retailer and received at the controlled-environment facility, such as via anonymous packaging and shipping provided by the retailer, for distribution to the resident. As noted, this packaging and shipping may be anonymous in that if a large online retailer is used, the volume of the packaging operations of a large online retailer (such as AMAZON®, WAL-MART®, or the like) and their use of a large shipping entity (such as FEDEX®, UPS®, the postal service, or the like) may provide this anonymity.

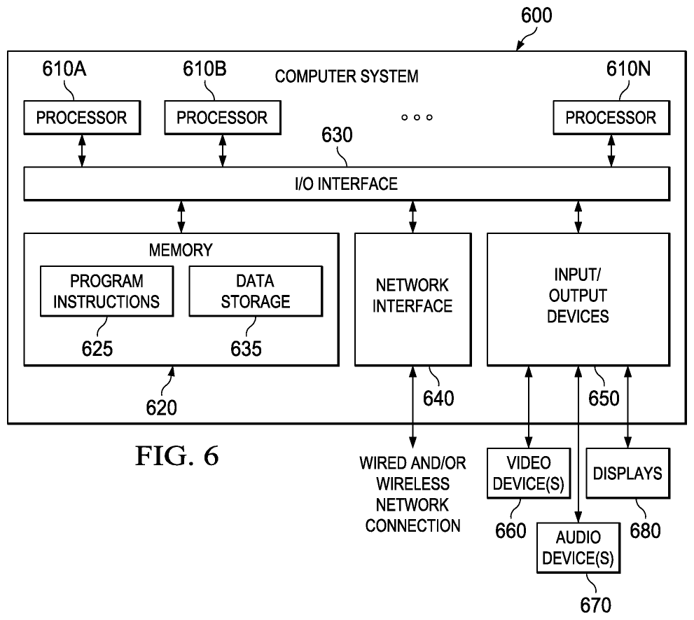

FIG. 6 is a block diagram of a computer system, device, station, or terminal configured to implement various techniques disclosed herein, according to some embodiments. Embodiments of the present systems and methods for providing a secure virtual controlled-environment facility storefront and providing payment for goods from the storefront using non-resident consumer cards by residents of the controlled-environment facility, as described herein, may be implemented or executed, at least in part, by one or more computer systems. One such computer system is illustrated in FIG. 6. In various embodiments, computer system 600 may be a server, a mainframe computer system, a workstation, a network computer, a desktop computer, a laptop, a tablet computing device, media player, or the like. For example, in some cases, computer 600 may implement one or more steps of example process implementation 500 described above with respect to FIG. 5, and/or a computer system such as computer system 600 may be used as, or as part of, one or more of communications processing system 110, 210, controlled-environment facility resident communication and/or media device (IFD 120, 220, 300 and IRD 125, 225, 400), a storefront provider system (165, 265), AMS 175, 275, resident account management system 180, 280, and/or the like. In various embodiments two or more of these computer systems may be configured to communicate with each other in any suitable way, such as, for example, via a network (e.g., in FIG. 1, devices and systems 110, 120, 125, 130, 175 are illustrated as communicating via (local area) network 185).

As illustrated, example computer system 600 includes one or more processors 610 coupled to a system memory 620 via an input/output (I/O) interface 630. Example computer system 600 further includes a network interface 640 coupled to I/O interface 630, and one or more input/output devices 650, such as video device(s) 660 (e.g., a camera), audio device(s) 670 (e.g., a microphone and/or a speaker), and display(s) 680. Computer system 600 may also include a cursor control device (e.g., a mouse or touchpad), a keyboard, etcetera. Multiple input/output devices 650 may be present in computer system 600 or may be distributed on various nodes of computer system 600. In some embodiments, similar input/output devices may be separate from computer system 600 and may interact with one or more nodes of computer system 600 through a wired or wireless connection, such as over network interface 640.

In various embodiments, computer system 600 may be a single-processor system including one processor 610, or a multi-processor system including two or more processors 610 (e.g., two, four, eight, or another suitable number). Processors 610 may be any processor capable of executing program instructions. For example, in various embodiments, processors 610 may be general-purpose or embedded processors implementing any of a variety of instruction set architectures (ISAs), such as the x86, POWERPC®, ARM®, SPARC®, or MIPS® ISAs, or any other suitable ISA. In multi-processor systems, each of processors 610 may commonly, but not necessarily, implement the same ISA. Also, in some embodiments, at least one processor 610 may be a graphics processing unit (GPU) or other dedicated graphics-rendering device.

System memory 620 may be configured to store program instructions and/or data accessible by processor 610. In various embodiments, system memory 620 may be implemented using any suitable memory technology, such as static random access memory (SRAM), synchronous dynamic RAM (SDRAM), nonvolatile/Flash-type memory, or any other type of memory. As illustrated, program instructions and data implementing certain operations, such as, for example, those described in connection with FIGS. 1 through 5, above, may be stored within system memory 620 as program instructions 625 and data storage 635, respectively. In other embodiments, program instructions and/or data may be received, sent or stored upon different types of computer-accessible media or on similar media separate from system memory 620 or computer system 600. Generally speaking, a computer-readable medium may include any tangible or non-transitory storage media or memory media such as magnetic or optical media—e.g., disk or CD/DVD-ROM coupled to computer system 600 via I/O interface 630, Flash memory, random access memory (RAM), etcetera. Program instructions and data stored on a tangible computer-accessible medium in non-transitory form may further be transmitted by transmission media or signals such as electrical, electromagnetic, or digital signals, which may be conveyed via a communication medium such as a network and/or a wireless link, such as may be implemented via network interface 640.

In some embodiments, I/O interface 630 may be configured to coordinate I/O traffic between processor 610, system memory 620, and any peripheral devices in the device, including network interface 640 or other peripheral interfaces, such as input/output devices 650. In some embodiments, I/O interface 630 may perform any suitable protocol, timing or other data transformations to convert data signals from one component (e.g., system memory 620) into a format usable by another component (e.g., processor 610). In some embodiments, I/O interface 630 may include support for devices attached through various types of peripheral buses, such as a variant of the Peripheral Component Interconnect (PCI) bus standard or the Universal Serial Bus (USB) standard, for example. In some embodiments, the function of I/O interface 630 may be split into two or more separate components, such as a north bridge and a south bridge, for example. In addition, in some embodiments, some or all of the functionality of I/O interface 630, such as an interface to system memory 620, may be incorporated into processor 610.

Network interface 640 may be configured to allow data to be exchanged between computer system 600 and other devices attached to a network, such as other computer systems, or between nodes of computer system 600. In various embodiments, network interface 640 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

As shown in FIG. 6, memory 620 may include program instructions 625, configured to implement certain embodiments described herein, and data storage 635, comprising various data accessible by program instructions 625. In an embodiment, program instructions 625 may include software elements corresponding to one or more of the various embodiments illustrated in the above figures. For example, program instructions 625 may be implemented in various embodiments using any desired programming language, scripting language, or combination of programming languages and/or scripting languages (e.g., C, C++, C #, JAVA®, JAVASCRIPT®, PERL®, etcetera). Data storage 635 may include data that may be used in these embodiments. In other embodiments, other or different software elements and data may be included.

A person of ordinary skill in the art will appreciate that computer system 600 is merely illustrative and is not intended to limit the scope of the disclosure described herein. In particular, the computer system and devices may include any combination of hardware or software that can perform the indicated operations. Additionally, the operations performed by the illustrated components may, in some embodiments, be performed by fewer components or distributed across additional components. Similarly, in other embodiments, the operations of some of the illustrated components may not be provided and/or other additional operations may be available. Accordingly, systems and methods described herein may be implemented or executed with other computer system configurations.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A secure virtual controlled-environment facility storefront system comprising:
a controlled-environment facility management system configured to select a subset of goods offered by a consumer retailer that are approved by a controlled-environment facility for purchase by a resident of the controlled-environment facility;
a controlled-environment facility communication management system configured to present the subset of goods offered by the consumer retailer that are approved by the controlled-environment facility for purchase by a resident of the controlled-environment facility as a secure virtual controlled-environment facility storefront accessible by controlled-environment communication and/or media devices; and
a controlled-environment facility resident account management system configured to:
accept and store, in association with the resident, consumer credit and/or debit card information that the resident may use to purchase the goods presented in the secure virtual controlled-environment facility storefront, the consumer credit and/or debit card information including at least one of a total spending limit the resident may use for purchases on the secure virtual controlled-environment facility storefront, a spending limit that the resident may use for a single transaction on the secure virtual controlled-environment facility storefront, a spending limit the resident may use for purchase of a single item on the secure virtual controlled-environment facility storefront, a spending limit the resident may use in a given time frame, and rules that limit what the resident may and/or may not purchase with the credit and/or debit card; and
provide the consumer credit and/or debit card information to the consumer retailer for payment for purchased goods.

2. The system of claim 1, wherein the controlled-environment facility resident account management system is further configured to determine whether the purchase of goods by the resident is permitted under the consumer credit and/or debit card information, prior to providing consumer credit and/or debit card information to the consumer retailer for payment for purchased goods.

3. (canceled)

4. The system of claim 1 wherein the controlled-environment facility management system selecting the subset of goods offered by the consumer retailer that are approved by the controlled-environment facility for purchase by the resident of the controlled-environment facility further comprises the controlled-environment facility management system selecting the subset of goods offered by the consumer retailer based upon an identity of a particular resident viewing the storefront on a controlled-environment communication and/or media device and what goods the particular resident is allowed to purchase.

5. The system of claim 1 wherein the controlled-environment facility management system selecting the subset of goods offered by the consumer retailer that are approved by the controlled-environment facility for purchase by the resident of the controlled-environment facility further comprises the controlled-environment facility management system selecting the subset of goods offered by the consumer retailer based upon an identity of a particular resident associated with the controlled-environment communication and/or media device being used to view the storefront and what goods the particular resident is allowed to purchase.

6. The system of claim 1, wherein the consumer retailer is an online retailer or the subset of goods offered by the consumer retailer is a subset of goods offered online by the consumer retailer.

7. The system of claim 1, wherein the consumer retailer is an existing online retailer.

8. The system of claim 1, wherein the consumer retailer packages and ships purchased goods via existing anonymous packaging and shipping channels employed by the consumer retailer.

9. A method for providing a secure virtual controlled-environment facility storefront, the method comprising:
offering, by a server associated with an existing online consumer retailer, access to a secure virtual controlled-environment facility storefront limited to access by controlled-environment systems and/or controlled-environment communication and/or media devices;
presenting, via a controlled-environment facility communication management system, in the secure virtual controlled-environment facility storefront, a subset of goods offered by the existing online consumer retailer that are approved by the controlled-environment facility for purchase by a resident of the controlled-environment facility;
storing, by a controlled-environment facility resident account management system, in association with the resident, consumer credit and/or debit card information the resident may use to purchase the goods; and
providing, by the controlled-environment facility resident account management system, the consumer credit and/or debit card information to the consumer retailer for payment for purchased goods.

10. The method of claim 9, wherein storing consumer credit and/or debit card information the resident may use to purchase the goods comprises storing a spending limit the resident may use to purchase goods from the secure virtual controlled-environment facility storefront, and the method further comprises determining by a controlled-environment facility management system whether the purchase of goods by the resident is permitted under the spending limit prior to providing other consumer credit and/or debit card information to the consumer retailer for payment for purchased goods.

11. The method of claim 10, wherein the spending limit is based on at least one of a total limit amount, a limit that may be used for a single transaction, a limit that may be used for purchase of a single item, a limit that may be used in a given time frame, the type of item that may be purchased, and a particular item that may be purchased.

12. The method of claim 9 wherein goods offered by the consumer retailer that are approved by the controlled-environment facility for purchase by the resident of the controlled-environment facility presented to a particular resident are goods offered by the consumer retailer that are approved by the controlled-environment facility for purchase by the particular resident.

13. The method of claim 12, further comprising determining an identity of the particular resident based upon identification information used to access a controlled-environment communication and/or media device being used to view the storefront.

14. The method of claim 12, further comprising determining an identity of the particular resident based upon identification of a particular controlled-environment communication and/or media device being used to view the storefront and identity of the particular resident associated with the device.

15. The method of claim 9, wherein the consumer retailer is an online retailer or the subset of goods offered by the consumer retailer is a subset of goods offered online by the retailer.

16. The method of claim 15, further comprising receiving the purchased goods at the controlled-environment facility, via anonymous packaging and shipping offered by the consumer retailer.

17. (canceled)

18. The method of claim 9, further comprising receiving the purchased goods at the controlled-environment facility, via existing anonymous packaging and shipping channels employed by the consumer retailer.

19. The method of claim 9, wherein the retailer is an online retailer and the method further comprises receiving the purchased goods at the controlled-environment facility, via existing anonymous packaging and shipping channels employed by the consumer retailer.

20. A non-transitory computer-readable storage medium having program instructions stored thereon that, upon execution by one or more computer systems, cause the one or more computer systems associated with a controlled-environment facility to:
present as a secure virtual controlled-environment facility storefront a subset of goods offered by an existing online consumer retailer that are approved by the controlled-environment facility for purchase by a resident of the controlled-environment facility;
limiting the secure virtual controlled-environment facility storefront to be accessible by at least one controlled-environment facility resident communication and/or media device and/or at least one controlled-environment facility communication and/or media station;
store, in association with the resident, consumer credit and/or debit card information the resident may use to purchase the goods, the consumer credit and/or debit card information including at least one of a total spending limit the resident may use for purchases on the secure virtual controlled-environment facility storefront, a spending limit that the resident may use for a single transaction on the secure virtual controlled-environment facility storefront, a spending limit the resident may use for purchase of a single item on the secure virtual controlled-environment facility storefront, a spending limit the resident may use in a given time frame, and rules that limit what the resident may and/or may not purchase with the credit and/or debit card;
determine whether the purchase of goods by the resident is permitted under, the consumer credit and/or debit card information and any remaining spending limit thereunder; and
provide the consumer credit and/or debit card information to the consumer retailer for payment for purchased goods in response to a determination that the purchase of goods by the resident falls within the consumer credit and/or debit card information and any remaining spending limit, thereunder.

21. The system of claim 1, wherein the controlled-environment facility communication management system presenting the subset of goods offered by the consumer retailer approved by the controlled-environment facility for purchase by the resident of the controlled-environment facility further comprises presenting access to the secure virtual controlled-environment facility storefront hosted by a server associated with an existing online consumer retailer.

22. The system of claim 21, wherein access to the secure virtual controlled-environment facility storefront hosted by a server associated with an existing online consumer retailer is limited to access by the controlled-environment communication and/or media devices.

23. The system of claim 1, wherein the spending limit is based on the type of item that may be purchased and/or a particular item that may be purchased.

24. (canceled)
